(19) United States
(12) Patent Application Publication
(10) Pub. No.: US 2017/0212373 A1
(43) Pub. Date: Jul. 27, 2017

(54) DISPLAY PANEL, DISPLAY DEVICE AND METHOD FOR DRIVING THE SAME

(71) Applicants: BOE Technology Group Co., Ltd., Beijing (CN); Beijing BOE Display Technology Co., Ltd., Beijing (CN)

(72) Inventors: Jiazuo Sai, Beijing (CN); Ming Tian, Beijing (CN); Hetao Wang, Beijing (CN); Feng Wang, Beijing (CN); Jianguo Xing, Beijing (CN)

(21) Appl. No.: 15/234,008

(22) Filed: Aug. 11, 2016

(30) Foreign Application Priority Data
Jan. 27, 2016 (CN) 201610055535.8

(51) Int. Cl. G02F 1/1341; G02F 1/1343; G02F 1/139; G09G 3/36; G02F 1/135

(52) U.S. Cl. CPC G02F 1/1341; G09G 3/3651; G02F 1/1358; G02F 1/1396; G02F 1/134309; G09G 2320/0233; G09G 2300/0426

(57) ABSTRACT

A display panel, a display device and a method for driving the same are provided by embodiments of the present invention, which belong to the technical field of display technology and is capable of solving the problem of a high consumption of time, human and material resources due to existing method for adjusting cell thickness of a liquid crystal cell and thus undesirable effect thereof. The display panel of the embodiments of the invention includes a first substrate, a second substrate and a frame sealant, the frame sealant is located between the first substrate and the second substrate and provided with an electrostrictive structure therein, the first substrate includes a first electrode provided to be corresponding to the electrostrictive structure, and the second substrate includes a second electrode provided to be corresponding to the electrostrictive structure, the first electrode and the second electrode forming an additional electric field to stretch or shorten the electrostrictive structure.

### CROSS-REFERENCE TO RELATED APPLICATION

This application claims the benefit of Chinese Patent Application No. 201610055535.8 filed on Jan. 27, 2016 in the State Intellectual Property Office of China, the whole disclosure of which is incorporated herein by reference.

### BACKGROUND OF THE INVENTION

Field of the Invention

Embodiments of the present invention relate to the technical field of display technology, and in particular to a display panel, a display device and a method for driving the same.

Description of the Related Art

In the prior art of this field, typically, a display panel comprises a first substrate, a second substrate and a frame sealant between the first substrate and the second substrate, liquid crystal being sealed within a liquid crystal cell formed by the first substrate and the second substrate via a cell assembly process, the liquid crystal cell being provided with a thickness which is referred to as ‘cell gap’, and the frame sealant having a primary function of sealing the liquid crystal cell to prevent liquid crystal from leakage therefrom and gas from entering therein.

An edge color non-uniformity (Mura) refers to a phenomenon of displaying various traces caused by luminance non-uniformity of a display panel when a cell gap at an edge of a display panel is too small or large, such that a periphery around an edge thereof presents a visual effect of whitening or darkening. To be specific, in case that a cell gap at an edge is smaller than that at a display zone, the edge presents a darkening phenomenon; whereas in case that a cell gap at the edge is larger than that at the display zone, the periphery around the edge presents a whitening phenomenon. Such poor display impacts product quality severely.

An existing method for solving such problem is to increase or decrease a cell gap at an edge of a liquid crystal panel by adjusting a height of a spacer within a display zone sealed by a frame sealant from inside of a liquid crystal panel, so as to eliminate drawbacks like edge Mura.

In the prior art, there are at least a problem as below: before an adjustment of the height of the spacer, since it may not be determined which size of a spacer is needed during the adjustment so as to produce a superior effect on undesirable phenomena like Mura, it is necessary to perform various engineering verifications to find out most appropriate cell gap value. Therefore, lots of time, human and material resources may be required for the verifications, with results which are not necessarily ideal.

### SUMMARY OF THE INVENTION

Embodiments of the present invention has been made to overcome or alleviate at least one aspect of the above mentioned disadvantages and/or shortcomings, by providing a display panel, a display device and a method for driving the same which may adjust a cell gap of a liquid crystal cell in a simple, fast and effective manner, for solving existing problem of a high consumption of time, human and material resources due to existing method for adjusting cell thickness of a liquid crystal cell and thus undesirable effect thereof.

Following technical solutions are adopted in exemplary embodiments of the invention for achieving the above desired technical purposes.

A display panel is provided by an exemplary embodiment of the invention, comprising a first substrate, a second substrate and a frame sealant, the frame sealant being located between the first substrate and the second substrate. The frame sealant is provided with an electrostrictive structure therein, the first substrate comprises a first electrode provided correspondingly in abutment against an end of the electrostrictive structure, and the second substrate comprises a second electrode provided correspondingly in abutment against the other end of the electrostrictive structure, the first electrode and the second electrode being configured to provide an additional electric field to stretch or shorten the electrostrictive structure.

As another technical solution, a display device is also provided by an exemplary embodiment of the invention, comprising the above display panel.

As still another technical solution, a method for driving a display device is also provided by an exemplary embodiment of the invention, the display device comprises a first substrate, a second substrate and a frame sealant, the frame sealant is located between the first substrate and the second substrate and provided with an electrostrictive structure therein, the first substrate comprises a first electrode provided correspondingly in abutment against an end of the electrostrictive structure while the second substrate comprises a second electrode provided correspondingly in abutment against other end of the electrostrictive structure, the method comprises the steps of: applying a first electrode voltage onto the first electrode and a second electrode voltage onto the second electrode respectively such that an additional electric field is provided between the first electrode and the second electrode; and controlling the electrostrictive structure to be stretched or shortened by magnitude of the additional electric field.

### BRIEF DESCRIPTION OF THE DRAWINGS

The above and other features and advantages of the present invention will become more apparent and a more comprehensive understanding of the present invention can be obtained, by describing in detail exemplary embodiments thereof with reference to the accompanying drawings, in which:

FIG. 1 illustrates a schematic structural view of a display panel according to exemplary embodiment I of the invention;

FIG. 2 illustrates a schematic structural view of an electrostrictive structure of the display panel as illustrated in FIG. 1, after being stretched;

FIG. 3 illustrates a schematic structural view of an electrostrictive structure of the display panel as illustrated in FIG. 1, after being shortened;

FIG. 4 illustrates a schematic structural view of a display panel according to exemplary embodiment II of the invention;

FIG. 5 illustrates a schematic structural view of an electrostrictive structure of the display panel as illustrated in FIG. 4, after being stretched;

FIG. 6 illustrates a schematic structural view of an electrostrictive structure of the display panel as illustrated in FIG. 4, after being shortened;

FIG. 7 illustrates a schematic structural view of a distribution of an electrostrictive structure of the display panel according to exemplary embodiment II of the invention; and

FIG. 8 illustrates a schematic flow chart of a method for driving a display device according to exemplary embodiment V of the invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms, and thus the detailed description of the embodiment of the invention in view of attached drawings should not be construed as being limited to the embodiment set forth herein; rather, these embodiments are provided so that the present disclosure will be thorough and complete, and will fully convey the general concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Respective thickness and shape of each layer are only intended to exemplarily illustrate the contents of the disclosure, rather than to demonstrate the practical dimension or proportion of the structure.

### Exemplary Embodiment I

According to a general technical concept of the present invention, as illustrated in FIGS. 1-3, there is provided a display panel, comprising a first substrate 1, a second substrate 2 and a frame sealant 3, the frame sealant 3 being located between the first substrate 1 and the second substrate 2 and provided with an electrostrictive structure 31 therein. The first substrate 1 comprises a first electrode 12 provided correspondingly in abutment against an end of the electrostrictive structure 31, and the second substrate 2 comprises a second electrode 22 provided correspondingly in abutment against the other end of the electrostrictive structure 31, both the first electrode 12 and the second electrode 22 forming an additional electric field so as to stretch or shorten the electrostrictive structure 31.

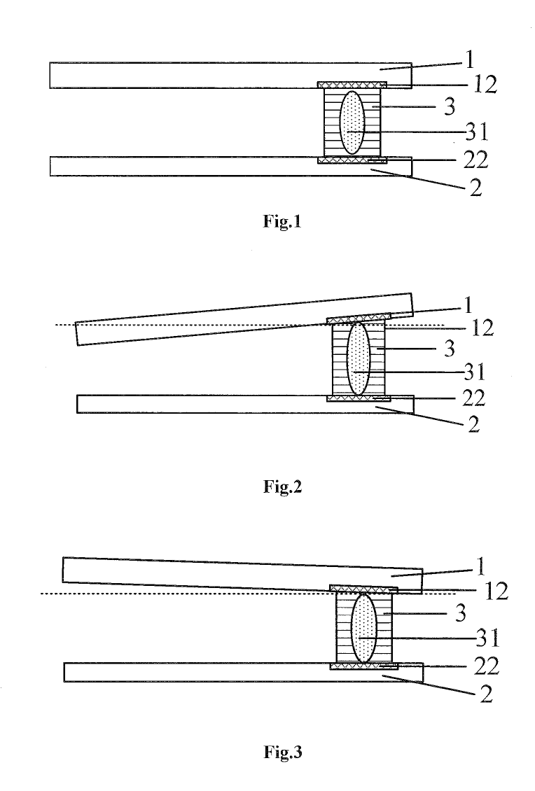

In other words, electrodes are arranged at both ends of the electrostrictive structure 31 provided within the frame sealant 3, and there will be an additional electric field formed between the first electrode 12 and the second electrode 22 when voltages are applied onto both the first electrode 12 and the second electrode 22 simultaneously. The electrostrictive structure 31 is located within the additional electric field. At that moment, the electrostrictive structure 31 may deform to various degrees, according to an electric field intensity of the additional electric field, i.e., to stretch/lengthen or shorten. By way of example, when the voltage applied on the first electrode 12 and the second electrode 22 increases, the electric field intensity formed between the first electrode 12 and the second electrode 22 also increases, such that the electrostrictive structure 31 is stretched to propan edge of the first substrate 1 higher (as illustrated in FIG. 2); and when the voltage applied on the first electrode 12 and the second electrode 22 decreases, the electric field intensity formed between the first electrode 12 and the second electrode 22 also decreases, such that the electrostrictive structure 31 is shortened to pull down and thus lower the edge of the first substrate 1 (as illustrated in FIG. 3).

It is of course possible to be configured to shorten the electrostrictive structure 31 as the electric field intensity formed between the first electrode 12 and the second electrode 22 increases, and to lengthen the electrostrictive structure 31 as the electric field intensity formed between the first electrode 12 and the second electrode 22 decreases, without repeating related contents any more.

The display panel of the present exemplary embodiment comprises a first substrate 1, a second substrate 2 and a frame sealant 3, the frame sealant 3 being located between the first substrate 1 and the second substrate 2 and provided with an electrostrictive structure 31 therein. The first substrate 1 comprises a first electrode 12 provided correspondingly in abutment against an end of the electrostrictive structure 31, and the second substrate 2 comprises a second electrode 22 provided correspondingly in abutment against the other end of the electrostrictive structure 31, the first electrode 12 and the second electrode 22 forming an additional electric field to stretch or shorten the electrostrictive structure 31. The electrostrictive structure 31 is provided within the frame sealant 3, and when a poor display caused by the cell gap occurs on the display panel, by adjusting the voltage applied at both ends of the electrostrictive structure 31, the electric field at both ends of the electrostrictive structure 31 may be changed and the electrostrictive structure 31 is in turn controlled to be stretched or to be shortened, so as to change the size of the cell gap, facilitating more convenient and accurate judgment, and hence obtaining a value of the cell gap suitable for solving an inferior display caused by the cell gap, with a compensation for the cell gap. When the cell gaps of the same batch of display panels are adjusted, such adjustment may be performed directly according to the voltage or cell gap values applied at both ends of the electrostrictive structure 31, saving a verification cost thereof to a large extent, and solving a problem of the inferior edge Mura caused by the poor display due to the cell gap, rapidly.

### Exemplary Embodiment II

Referring to FIGS. 4-7, a display panel is provided by the present embodiment, comprising a first substrate 1, a second substrate 2 and a frame sealant 3, the frame sealant 3 being located between the first substrate 1 and the second substrate 2 and provided with an electrostrictive structure 31 therein. The first substrate 1 comprises a first electrode 12 provided correspondingly in abutment against an end of the electrostrictive structure 31, and the second substrate 2 comprises a second electrode 22 provided correspondingly in abutment against the other end of the electrostrictive structure 31, the first electrode 12 and the second electrode 22 forming an additional electric field to stretch or shorten the electrostrictive structure 31.

Referring to FIG. 4, the first substrate 1 of the display panel of the exemplary embodiment comprises: a first base substrate 11, a first electrode 12, a first alignment layer 13, a color filter layer 14 and a black matrix 15. The black matrix 15 is provided at one side of the first base substrate 11 facing towards the second substrate 2, the black matrix 15 being arranged to be not only opposed to the frame sealant 3 but also supported by and opposed to a spacer 4 arranged within a display zone surrounded and delimited by the frame sealant 3. The black matrix 15 is covered by the color filter layer 14 which extends beyond the black matrix and is attached directly onto a portion of the first base substrate 11 which is configured to be opposed to a portion of the display zone unoccupied by the spacer 4. And the color filter layer 14 and the black matrix 15 are both covered by the first electrode 12, a side of which faces away from the black matrix 15 is provided with a first alignment layer 13, the first alignment layer 13 being in contact with the frame sealant 3 at an edge thereof.

The second substrate 2 comprises: a second base substrate 21, a second electrode 22, a protective layer 23, a second alignment layer 24, an insulative layer 25, a metallic layer 26 and a thin film transistor 27. The second electrode 22 and the metallic layer 25 are provided at one side of the second base substrate 21 facing towards the first substrate 1, the second electrode 22 being arranged to be in alignment with the frame sealant 3, and the metallic layer 26 is configured to be opposite to the spacer 4 in the display zone. The second electrode 2 and the metallic layer 26 are covered by the insulative layer 25, and the thin film transistor 27 is provided at a position aligned with the spacer on the insulative layer 25, with the protective layer 23 being provided above the thin film transistor 27 and the insulative layer 25. Moreover, the second alignment layer 24 is provided above the protective layer 23 within the display zone. Above structures are illustrated in FIG. 4, without repeating related contents any more.

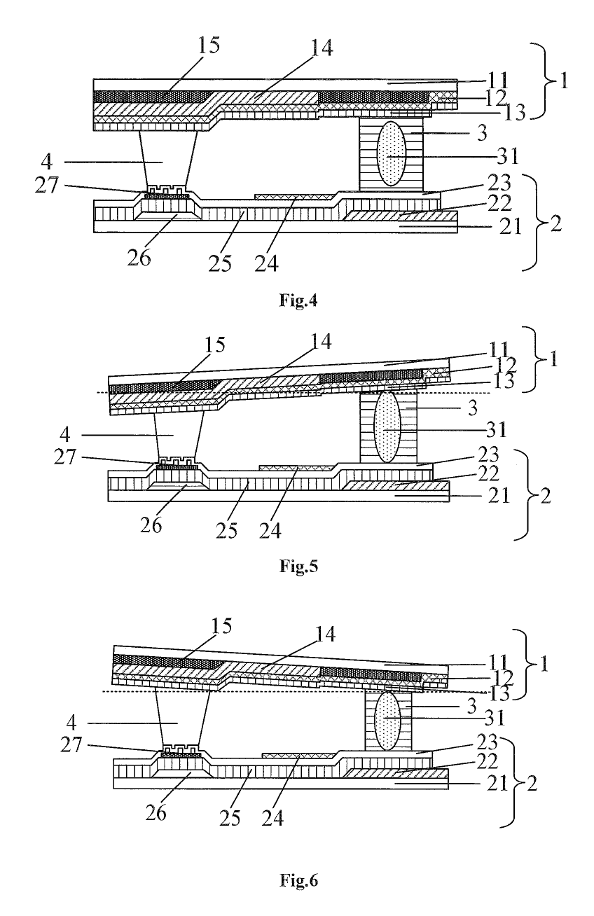

In other words, electrodes are arranged at both ends of the electrostrictive structure 31 provided within the frame sealant 3, and there will be an additional electric field formed between the first electrode 12 and the second electrode 22 when voltages are applied onto both the first electrode 12 and the second electrode 22 simultaneously. The electrostrictive structure 31 is located within the additional electric field. At that moment, the electrostrictive structure 31 may deform to various degrees, according to an electric field intensity of the additional electric field, i.e., to stretch/lengthen or shorten. By way of example, when the voltage applied on the first electrode 12 and the second electrode 22 increases, the electric field intensity formed between the first electrode 12 and the second electrode 22 also increases, such that the electrostrictive structure 31 is stretched to propan edge of the first substrate 1 higher (as illustrated in FIG. 5); and when the voltage applied on the first electrode 12 and the second electrode 22 decreases, the electric field intensity formed between the first electrode 12 and the second electrode 22 also decreases, such that the electrostrictive structure 31 is shortened to pull down and thus lower the edge of the first substrate 1 (as illustrated in FIG. 6).

It is of course possible to be configured to shorten the electrostrictive structure 31 as the electric field intensity formed between the first electrode 12 and the second electrode 22 increases, and to lengthen the electrostrictive structure 31 as the electric field intensity formed between the first electrode 12 and the second electrode 22 decreases, without repeating related contents any more.

By changing the electric field at both ends of the electrostrictive structure 31 so as to control the lengthening and shortening of the electrostrictive structure 31 and in turn to change the size of the cell gap, facilitating more convenient and accurate judgment of a required value of the cell gap intended for solving an inferior display caused by the cell gap.

An extending or retracting amount of the electrostrictive structure 31 is represented by Xᵢ which is defined by Xᵢ=Mᵢₖ×E², where Mᵢₖ is a coefficient of the electrostriction of the electrostrictive structure 31 and E being a voltage value between the first electrode 12 and the second electrode 22.

It should be noticed that, the coefficients of the electrostriction of the electrostrictive structure 31 formed by different materials of the electrostrictive structure differ from one another. Therefore, such coefficient of the electrostriction of the electrostrictive structure should be adjusted as required during calculations by the above equation. From the above equation, it can be seen that, the extending or retracting amount of the electrostrictive structure 31 is calculated accurately according to the voltage applied between the first electrode 12 and the second electrode 22, and a need of an addition of 1-2 μm of the extending or retracting amount may be fulfilled completely by adjusting the voltage applied between the first electrode 12 and the second electrode 22, such that an accurate adjustment for the extending or retracting amount may also be obtained, with high accuracy. Meanwhile, by way of example, a variation of the cell gap may be obtained according to the voltage applied between the first electrode 12 and the second electrode 22, functioning as a reference basis for a next adjustment of the cell gap of the display panel of the same electrostrictive structure 31, such that a verification cost thereof (time, human and material resources) may be saved to a large extent, and a problem of the inferior edge Mura caused by poor display due to the cell gap may be solved, rapidly.

By way of example, the electrostrictive structure 31 is formed by a relaxation ferroelectric ceramic material which is provided with lead magnesium niobate as a matrix.

It should be noticed that, the material for preparing the electrostrictive structure 31 may not be limited to a relaxation ferroelectric ceramic material with a lead magnesium niobate matrix, since the electrostrictive structure 31 may be formed by one or more materials comprising: a ferroelectric ceramics (PMN) material with a lead magnesium matrix, a lead magnesium niobate (PMN) ceramics material, a ternary solid solution bi-relaxation ferroelectric or an electro-optic (PLZT) ceramics material, without repeating related contents any more.

A shape of the electrostrictive structure is one chosen from a group comprising the following shapes: cylinder, cube, stereoscopic trapezoid shape, and sphere shape.

It should be noticed that, upon setting up the shape of the electrostrictive structure 31, for example, a height of the electrostrictive structure 31 in a vertical direction is set above a width in a horizontal direction, facilitating stretching or shortening of the electrostrictive structure 31 in the vertical direction, upon action of the electric field thereon, so as to increase or decrease the distance between the first substrate 1 and the second substrate 2. Taking an electrostrictive structure 31 of a cylinder shape for example, the cylinder is vertically arranged between the first substrate 1 and the second substrate 2, with two round bottom surfaces being in contact with the first substrate 1 and the second substrate 2 respectively, such that upon action of an electric field, the two round bottom surfaces abut against the first substrate 1 and the second substrate 2 respectively and stretch or shorten in the vertical direction therebetween, so as to increase or decrease the distance between the first substrate 1 and the second substrate 2.

Above stereoscopic trapezoid shape refers to a stereoscopic structure with its top surface and bottom surface being parallel to the planes of the first substrate 1 and the second substrate 2, and the cross section of the stereoscopic structure is configured to be a trapezoid shape cross section, and such design of the stereoscopic trapezoid shape structure may ensure that the liquid crystal panel is supported in a more secured and stable manner. Furthermore, a sphere shape design may minimize a contact portion between the electrostrictive structure 31 and the first substrate 1 and the second substrate 2 as much as possible so as to save space therebetween, facilitating setting up of other structure(s) on the first substrate 1 and the second substrate 2.

It is of course possible to choose other shapes of the electrostrictive structure 31, not being limited as above; alternatively, it is also possible to choose other materials for forming the electrostrictive structure 31. Related contents are not be repeated herein any more.

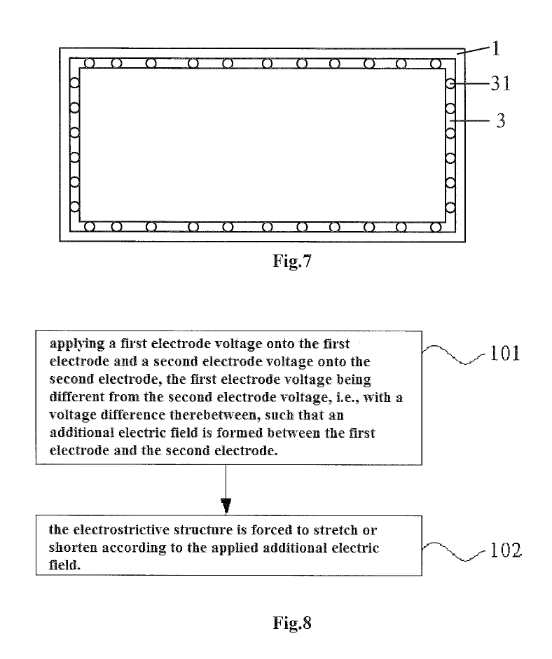

As illustrated in FIG. 7, the electrostrictive structure 31 is provided evenly within the frame sealant 3.

By way of example, the electrostrictive structure 31 is provided evenly within the frame sealant 3, such that the extending or retracting force at various positions across the frame sealant is identical, when the electrostrictive structure 31 is forced to stretch or to shorten upon action of the electric field, resulting in the same height of lengthening or shortening.

Herein, the display panel is configured to be a twisted nematic display panel (i.e., a TN type display panel).

The reason of adopting such TN type display panel lies in that a first substrate 1 (upper substrate) of a TN type display panel typically comprises a first electrode 12 (common electrode), in this exemplary embodiment, it is possible that an area of the first electrode 12 directly changes its own positioning from an original position where only the display zone is covered, to extend outwards further to another position where an outer frame of the frame sealant 3 is also covered, such that when the display panel may be driven to display, it is only necessary that a second voltage is applied onto the second electrode 22. As such, it is not necessary to provide an additional electrode within the first substrate 1, facilitating a simpler structure. It is of course that the specific type of the display panel may not be limited as above, for example, the display panel may also be an advance super dimension switching mode (ADS mode) display panel or an in-plane switching mode (IPS mode) display panel, it is only necessary that an additional electrode corresponding to the frame sealant 3 is provided within the first substrate 1, with an operating principle identical to that of the present exemplary embodiment, without repeating related contents any more.

The display panel of the present exemplary embodiment, comprises a first substrate 1, a second substrate 2 and a frame sealant 3, the frame sealant 3 being located between the first substrate 1 and the second substrate 2 and provided with an electrostrictive structure 31 therein. The first substrate 1 comprises a first electrode 12 provided to be corresponding to the electrostrictive structure 31, and the second substrate 2 comprises a second electrode 22 provided to be corresponding to the electrostrictive structure 31, the first electrode 12 and the second electrode 22 forming an additional electric field to stretch or shorten the electrostrictive structure 31. The electrostrictive structure 31 is provided within the frame sealant 3, and when a poor display caused by the cell gap occurs on the display panel, it is necessary to control the electrostrictive structure 31 to be stretched or to be shortened and in turn to change the size of the cell gap, by adjusting the voltage applied at both ends of the electrostrictive structure 31 to change the electric field at both ends of the electrostrictive structure 31, facilitating more convenient and accurate judgment so as to obtain a value of the cell gap suitable for solving an inferior display caused by the cell gap. When the cell gaps of the same batch of display panels are adjusted, such adjustment may be performed directly according to the voltage or cell gap values applied at both ends of the electrostrictive structure 31, saving a verification cost thereof to a large extent, and solving a problem of the inferior edge Mura caused by poor display due to the cell gap, rapidly.

### Exemplary Embodiment III

A display device is provided by the present embodiment, comprising a display panel according to exemplary embodiment I or II. By way of example, the display panel may be a product or a component with display function, such as liquid crystal display panel, an electronic paper, a mobile phone, a tablet computer, a Television set, a display, a laptop computer, a digital photo frame, a navigator, and so on.

The display device of the present embodiment comprises a display panel according to exemplary embodiment I or II. The display panel comprises a first substrate 1, a second substrate 2 and a frame sealant 3, the frame sealant 3 being located between the first substrate 1 and the second substrate 2 and provided with an electrostrictive structure 31 therein. The first substrate 1 comprises a first electrode 12 provided to be corresponding to the electrostrictive structure 31, and the second substrate 2 comprises a second electrode 22 provided to be corresponding to the electrostrictive structure 31, the first electrode 12 and the second electrode 22 forming an additional electric field to stretch or shorten the electrostrictive structure 31. The electrostrictive structure 31 is provided within the frame sealant 3, and when a poor display caused by the cell gap occurs on the display panel, it is necessary to control the electrostrictive structure 31 to be stretched or to be shortened and in turn to change the size of the cell gap by adjusting the voltage applied at both ends of the electrostrictive structure 31 to change the electric field at both ends of the electrostrictive structure 31, facilitating more convenient and accurate judgment so as to obtain a value of the cell gap suitable for solving an inferior display caused by the cell gap. When the cell gaps of the same batch of display panels are adjusted, such adjustment may be performed directly according to the voltage or cell gap values applied at both ends of the electrostrictive structure 31, saving a verification cost thereof to a large extent, and solving a problem of the inferior edge Mura caused by poor display due to the cell gap, rapidly.

### Exemplary Embodiment IV

Referring to FIG. 8, a method for driving a display device is provided by the present embodiment, the display device comprising a display panel. The display panel comprises a first substrate 1, a second substrate 2 and a frame sealant 3, the frame sealant 3 being located between the first substrate 1 and the second substrate 2 and provided with an electrostrictive structure 31 therein. The first substrate 1 comprises a first electrode 12 provided to be corresponding to the electrostrictive structure 31, and the second substrate 2 comprises a second electrode 22 provided to be corresponding to the electrostrictive structure 31.

The method comprises:

Step 101, applying a first electrode voltage onto the first electrode 12 and a second electrode voltage onto the second electrode 22, the first electrode voltage being different from the second electrode voltage, i.e., with a voltage difference therebetween, such that an additional electric field is formed between the first electrode 12 and the second electrode 22.

Step 102, the electrostrictive structure is forced to be stretched or shortened according to the applied additional electric field.

To be specific, for example, a magnitude of the additional electric field formed between the first electrode 12 and the second electrode 22 is adjusted (i.e., changing magnitude(s) of the first electrode voltage and/or the second electrode voltage), by adjusting a magnitude of the voltage difference between the first electrode voltage and the second electrode voltage. Moreover, the electrostrictive structure 31 is controlled to be stretched or shortened by the magnitude of the formed additional electric field.

In other words, electrodes are arranged at both ends of the electrostrictive structure 31 provided within the frame sealant 3, and there will be an additional electric field formed between the first electrode 12 and the second electrode 22 when voltages are applied onto both the first electrode 12 and the second electrode 22 simultaneously. The electrostrictive structure 31 is located within the additional electric field. At that moment, the electrostrictive structure 31 may deform to various degrees, according to an electric field intensity of the additional electric field, i.e., to stretch/lengthen or shorten. By way of example, when the voltage applied on the first electrode 12 and the second electrode 22 increases, the electric field intensity formed between the first electrode 12 and the second electrode 22 also increases, such that the electrostrictive structure 31 is stretched to propan edge of the first substrate 1 higher; and when the voltage applied on the first electrode 12 and the second electrode 22 decreases, the electric field intensity formed between the first electrode 12 and the second electrode 22 also decreases, such that the electrostrictive structure 31 is shortened to pull down and thus lower the edge of the first substrate 1.

The method for driving the display device provided by the present embodiment takes advantage of the display device of exemplary embodiment III. The display device is provided with an electrostrictive structure 31 within the frame sealant 3, and when a poor display caused by the cell gap occurs on the display panel, it is necessary to control the electrostrictive structure 31 to be stretched or to be shortened and in turn to change the size of the cell gap by adjusting the voltage applied at both ends of the electrostrictive structure 31 to change the electric field at both ends of the electrostrictive structure 31, facilitating more convenient and accurate judgment so as to obtain a value of the cell gap suitable for solving an inferior display caused by the cell gap. When the cell gaps of the same batch of display panels are adjusted, such adjustment may be performed directly according to the voltage or cell gap values applied at both ends of the electrostrictive structure 31, saving a verification cost thereof to a large extent, and solving a problem of the inferior edge Mura caused by poor display due to the cell gap, rapidly.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although the disclosure is described in view of the attached drawings, the embodiments disclosed in the drawings are only intended to illustrate the preferable embodiment of the present invention exemplarily, and should not be deemed as a restriction thereof.

Although several exemplary embodiments of the general concept of the present invention have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

### LIST OF REFERENCE NUMERALS

1 first substrate
11 first base substrate
12 first electrode
13 first alignment layer
14 color filter layer
15 black matrix
2 second substrate
21 second base substrate
22 second electrode
23 protective layer
24 second alignment layer
25 insulative layer
26 metallic layer
27 thin film transistor
3 frame sealant
31 electrostrictive structure
4 spacer

What is claimed is:

1. A display panel, comprising a first substrate, a second substrate and a frame sealant, the frame sealant being located between the first substrate and the second substrate,
wherein the frame sealant is provided with an electrostrictive structure therein, the first substrate comprises a first electrode provided correspondingly in abutment against an end of the electrostrictive structure, and the second substrate comprises a second electrode provided correspondingly in abutment against other end of the electrostrictive structure, the first electrode and the second electrode being configured to provide an additional electric field so as to stretch or shorten the electrostrictive structure.

2. The display panel according to claim 1,
wherein an amount of extending or retracting of the electrostrictive structure is represented by Xᵢ and is defined by Xᵢ=Mᵢₖ×E², where Mᵢₖ is a coefficient of the electrostriction of the electrostrictive structure and E being a voltage value between the first electrode and the second electrode.

3. The display panel according to claim 1,
wherein the electrostrictive structure is formed by a relaxation ferroelectric ceramic material which is provided with lead magnesium niobate as matrix.

4. The display panel according to claim 1,
wherein a shape of the electrostrictive structure is one chosen from a group comprising following shapes: cylinder, cube, stereoscopic trapezoid shape, and sphere shape.

5. The display panel according to claim 1,
wherein the electrostrictive structure is provided evenly within the frame sealant.

6. The display panel according to claim 1,
wherein the display panel is configured to be a twisted nematic display panel.

7. A display device, comprising the display panel according to claim 1.

8. A method for driving a display device, wherein the display device comprises a first substrate, a second substrate and a frame sealant, the frame sealant is located between the first substrate and the second substrate and provided with an electrostrictive structure therein, the first substrate comprises a first electrode provided correspondingly in abutment against an end of the electrostrictive structure while the second substrate comprises a second electrode provided correspondingly in abutment against the other end of the electrostrictive structure, the method comprises the steps of:
applying a first electrode voltage onto the first electrode and a second electrode voltage onto the second electrode respectively such that an additional electric field is provided between the first electrode voltage and the second electrode voltage; and
controlling the electrostrictive structure to be stretched or shortened by magnitude of the additional electric field.
